(19) United States
(12) Patent Application Publication
(10) Pub. No.: US 2006/0256127 A1
(43) Pub. Date: Nov. 16, 2006

(54) Display apparatus and control method thereof

(76) Inventors: Cheon-yong Cho, Yongin-si (KR); Joung-hum Baek, Suwon-si (KR); Hyun-young Jang, Seoul (KR)

Correspondence Address: STANZIONE & KIM, LLP, 919 18TH STREET, N.W., SUITE 440, WASHINGTON, DC, 20006, US

(21) Appl. No.: 11/352,232

(22) Filed: Feb. 13, 2006

(30) Foreign Application Priority Data
May 10, 2005 (KR) 2005-38943

(51) Int. Cl. G09G 5/02

(52) U.S. Cl. 345/591

(57) ABSTRACT

A method of controlling a display apparatus having a display part to display an image thereon includes displaying a first graphic user interface on the display part to determine whether a user has color weakness, determining whether the user has the color weakness based on a first test signal which is input through the first graphic user interface, displaying a second graphic user interface having an information graphic user interface to display information regarding a process of determining a degree of the color weakness, and at least one determination graphic user interface to determine the degree of the color weakness based on at least one gradation of brightness and saturation with respect to at least one color, on the display part if it is determined that the user has the color weakness, determining the degree of the color weakness based on a second test signal which is input through the second graphic user interface, and setting a color weakness mode corresponding to the determined degree of the color weakness. Accordingly, the display apparatus determines whether a user has color weakness and a degree of the color weakness to adjust display characteristics of an image displayed on a display part according to the degree of color weakness.

### CROSS-REFERENCE TO RELATED APPLICATIONS

This application claims the benefit under 35 U.S.C. § 119 of Korean Patent Application No. 2005-38943, filed on May 10, 2005, in the Korean Intellectual Property Office, the disclosure of which is incorporated herein in its entirety.

### BACKGROUND OF THE INVENTION

1. Field of the Invention

The present general inventive concept relates to a display apparatus, and more particularly, to a display apparatus and a control method thereof which determines whether a user has color weakness and a degree of the color weakness to adjust display characteristics of an image displayed on a display part corresponding to the degree of the color weakness.

2. Description of the Related Art

Color vision refers to an ability to distinguish and recognize colors. If the color vision is weak, it is called color weakness. Also, lack of the color vision is called color blindness. Such a color vision disability results in lack of color recognition of red, green, and blue (RGB) colors.

The color vision disability may be inherited or caused by disease. Eight percent of the population is estimated to suffer from the inherited color vision disability.

Display apparatuses, such as monitors or TVs, etc., display color images and realize the color images close to the real color due to developments in color realization techniques.

However, even if the display apparatuses realize the color images close to the real color, a user with the color vision disability may not correctly distinguish the image displayed on the display apparatuses.

The display apparatus manufacturers offer a function of individually adjusting colors of red, green, and blue to help a user correctly distinguish the image.

However, the function of adjusting the colors may cause inconvenience both for a user with normal color vision and a user with the color vision disability, as the display apparatuses should be adjusted to a normal mode for the user with the normal color vision, and readjusted for the user with the color vision disability.

Also, if a user does not know that he/she has the color weakness, the user may use the display apparatus without correctly adjusting the colors.

It is desirable that a user is able to check whether he/she has the color weakness without difficulty and adjust color display conditions of an image displayed by a display apparatus according to a degree of the color weakness.

### SUMMARY OF THE INVENTION

Accordingly, the present general inventive concept provides a display apparatus and a control method thereof which determines whether a user has color weakness and a degree of the color weakness to adjust display characteristics of an image displayed on a display part corresponding to the degree of the color weakness.

Additional aspects an utilities of the present general inventive concept will be set forth in part in the description which follows and, in part, will be obvious from the description, or may be learned by practice of the present general inventive concept.

The foregoing and/or other aspects of the present general inventive concept are achieved by providing a method of controlling a display apparatus having a display part to display an image thereon, the method comprising displaying a first graphic user interface on the display part to determine whether a user has color weakness, determining whether user has the color weakness based on a first test signal which is input through the first graphic user interface, displaying a second graphic user interface having an information graphic user interface to display information regarding a process of determining a degree of the color weakness, and at least one determination graphic user interface to determine the degree of the color weakness based on at least one gradation of brightness and saturation with respect to at least one color, on the display part if it is determined that the user has the color weakness, determining the degree of the color weakness based on a second test signal which is input through the second graphic user interface, and setting a color weakness mode corresponding to the determined degree of the color weakness.

The method may further comprise displaying a color weakness set graphic user interface which is provided with a reset menu, a color weakness mode menu to select at least one color weakness mode and a color weakness test menu, on the display part, wherein the displaying of the first graphic user interface on the display part is performed by selecting the color weakness test menu of the displayed color weakness set graphic user interface.

The method may further comprise displaying an image on the display part in a normal mode corresponding to selection of the reset menu of the displayed color weakness set graphic user interface, and when the at least one color weakness mode of the color weakness mode menu is selected, displaying the image on the display part in a color weakness mode which is set corresponding to the selected color weakness mode.

The color weakness set graphic user interface may further comprise a red control drag bar, a green control drag bar, and a blue control drag bar, and the method may further comprise selecting one of the at least one color weakness mode of the color weakness mode menu, activating the red control drag bar, the green control drag bar, and the blue control drag bar in a controllable state corresponding to the selection of the color weakness mode, and displaying the image on the display part corresponding to control of at least one of the red control drag bar, the green control drag bar, and the blue control drag bar, as the selected color weakness mode.

The color weakness set graphic user interface may further comprise an initialization menu, and the further comprises initializing the color weakness mode corresponding to the selection of the initialization menu.

The first graphic user interface may comprise a color weakness test image and a test input window to input the first test signal corresponding to the color weakness test image.

The determining of whether the user has the color weakness may comprise displaying at least two color weakness test images on the first graphic user interface sequentially, inputting the first test signal in the test input window corresponding to each of the sequentially displayed color weakness test images, and determining that the user has the color weakness if the color weakness test images and the first test signal are not identical to each other more than a predetermined number of times.

The first graphic user interface may further comprise a next menu, wherein the displaying of the at least two color weakness test images sequentially comprises displaying a next one of the at least two color weakness test images on the first graphic user interface whenever the next menu is selected.

The method may further comprise displaying a normal vision information display window on the display part to display information representing that the user has a normal color vision if the color weakness test images and the first test signal are identical to each other more than the predetermined number of times.

The displaying of the second graphic user interface on the display part may be performed when it is determined that the user has the color weakness.

The setting of the color weakness mode corresponding to the determined degree of the color weakness may comprise displaying a mode set window which includes at least one determination mode menu corresponding to the at least one color weakness mode of the color weakness mode menu of the color weakness set graphic user interface, on the display part when the degree of the color weakness is determined through the determination graphic user interface, and setting the color weakness mode corresponding to the determined degree of the color weakness as the at least one color weakness mode of the color weakness mode menu corresponding to the at least one determination mode menu if the at least one determination mode menu is selected.

The foregoing and/or other aspects of the present general inventive concept are also achieved by providing a method of controlling a display apparatus comprising receiving first input signals and determining whether a user has a color weakness based on the first input signals, receiving second input signals and determining a degree of the color weakness based on the second input signals if it is determined that the user has the color weakness, and adjusting display characteristics of the display apparatus according to the determined degree of the color weakness.

The foregoing and/or other aspects of the present general inventive concept are also achieved by providing a display apparatus comprising a display part to display an image thereon, an image processor to convert an image signal into a signal which is displayable by the display part, and a controller to control the display part to display a first graphic user interface to determine whether a user has color weakness and a second graphic user interface having an information graphic user interface to display information regarding a process of determining a degree of the color weakness and at least one determination graphic user interface to determine the degree of the color weakness based on at least one gradation of brightness and saturation with respect to at least one color, to determine whether the user has the color weakness based on a first test signal which is input through the first graphic user interface, to determine the degree of the color weakness based on a second test signal which is input through the second graphic user interface, and to set a color weakness mode corresponding to the determined degree of color weakness.

The controller may comprise a first controller which is provided in an external device to apply the image signal to the image processor, to apply graphic user interface image signals corresponding to the first graphic user interface and the second graphic user interface to the image processor, and to determine whether the user has the color weakness and the degree of the color weakness according to the first test signal and the second test signal, and a second controller to control the image processor to change color display characteristics of the image displayed on the display part according to a control signal from the first controller corresponding to the determined degree of the color weakness.

The first and second controllers may communicate with each other through a display data communication (DDC) communication line.

The controller may control the display part to display a color weakness set graphic user interface which includes a reset menu, a color weakness test menu, and a color weakness mode menu to select at least one color weakness mode, and to display the first graphic user interface when the color weakness test menu is selected.

The controller may control the image processor to set color display characteristics of the image displayed on the display part to a predetermined normal mode when the reset menu is selected, and may control the image processor to set the color display characteristics of the image displayed on the display part to correspond to the selected at least one color weakness mode when the at least one color weakness mode of the color weakness mode menu is selected.

The color weakness set graphic user interface may further comprise a red control drag bar, a green control drag bar, and a blue control drag bar, and the controller may activate the red control drag bar, the green control drag bar, and the blue control drag bar to be in a controllable state when one of the at least one color weakness mode of the color weakness mode menu is selected, and may control the image processor to adjust display characteristics of the image displayed on the display part corresponding to control of at least one of the red control drag bar, the green control drag bar, and the blue control drag bar.

The color weakness set graphic user interface may further comprise an initialization menu, and the controller may initialize a preset color weakness mode according to selection of the initialization menu if the initialization menu is selected.

The first graphic user interface may include at least two color weakness test images sequentially displayed on the display part, and the controller may determine that the user has the color weakness if the first test signal input corresponding to the sequentially displayed color weakness test images is not identical with the color weakness test images a predetermined number of times.

The controller may control the display part to display an information display window to display information that a user has a normal color vision if the first test signal is identical with the color weakness test images more than the predetermined number of times.

The controller may control the display part to display a mode set window which is provided with at least one determination mode menu corresponding to the at least one color weakness mode of the color weakness mode menu of the color weakness set graphic user interface when the degree of the color weakness is determined through the determination graphic user interface, and may set the color weakness mode corresponding to the determined degree of the color weakness as the at least one color weakness mode of the color weakness mode menu corresponding to the at least one determination mode menu if the at least one determination mode menu is selected.

The foregoing and/or other aspects of the present general inventive concept are also achieved by providing a display apparatus comprising a display part to display first and second graphic user interfaces, and a controller to determine whether a user has a color weakness based on the displayed first graphic user interface, to determine a degree of the color weakness based on the displayed second graphic user interface when it is determined that the user has the color weakness, and to adjust display characteristics of the display part according to the determined degree of the color weakness.

The foregoing and/or other aspects of the present general inventive concept are also achieved by providing a display apparatus comprising a display part to display a plurality of test images thereon to test whether a user has a color weakness and to display a plurality of gradations of each of a plurality of colors thereon to test a degree of the color weakness, a user input part to generate first signals corresponding to the plurality of test images displayed on the display, to arrange the plurality of gradations of each of the plurality of colors according color saturation, and to generate second signals corresponding to the arrangement of the gradations of each of the plurality of colors, and a controller to compare the first signals to the test images to determine whether the user has the color weakness and to compare the second signals with a predetermined normal arrangement of the gradations of each of the plurality of colors to determine the degree of the color weakness for each of the plurality of colors when is determined that the user has the color weakness.

The foregoing and/or other aspects of the present general inventive concept are also achieved by providing a display system, comprising a display unit comprising a display part to display an image thereon and a display controller to control display characteristics of the display part, and a computer communicating with the display unit and comprising a control unit to control the display unit to display a first graphic user interface and a second graphic user interface, to determine whether a user has a color weakness based on the displayed first graphic user interface, to determine a degree of the color weakness based on the displayed second graphic user interface when it is determined that the user has the color weakness, and to control the display controller to adjust the display characteristics of the display part according to the determined degree of the color weakness.

The foregoing and/or other aspects of the present general inventive concept are also achieved by providing a computer readable recording medium having executable codes to perform a method of controlling a display apparatus having a display part to display an image thereon, the method comprising displaying a first graphic user interface on the display part to determine whether a user has color weakness, determining whether the user has the color weakness based on a first test signal which is input through the first graphic user interface, displaying a second graphic user interface having an information graphic user interface to display information regarding a process of determining a degree of the color weakness, and at least one determination graphic user interface to determine the degree of the color weakness based on at least one gradation of brightness and saturation with respect to at least one color, on the display part if it is determined that the user has the color weakness, determining the degree of the color weakness based on a second test signal which is input through the second graphic user interface, and setting a color weakness mode corresponding to the determined degree of the color weakness.

The foregoing and/or other aspects of the present general inventive concept are also achieved by providing a computer readable recording medium having executable codes to perform a method of controlling a display apparatus, the method comprising receiving first input signals and determining whether a user has a color weakness based on the first input signals, receiving second input signals and determining a degree of the color weakness based on the second input signals if it is determined that the user has the color weakness, and adjusting display characteristics of the display apparatus according to the determined degree of the color weakness.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a control block diagram illustrating a display apparatus according to an embodiment of the present general inventive concept;

FIGS. 2 through 9 are views illustrating examples of a graphic user interfaces displayed by the display apparatus of FIG. 1; and

FIG. 10 is a control block diagram illustrating a display apparatus according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

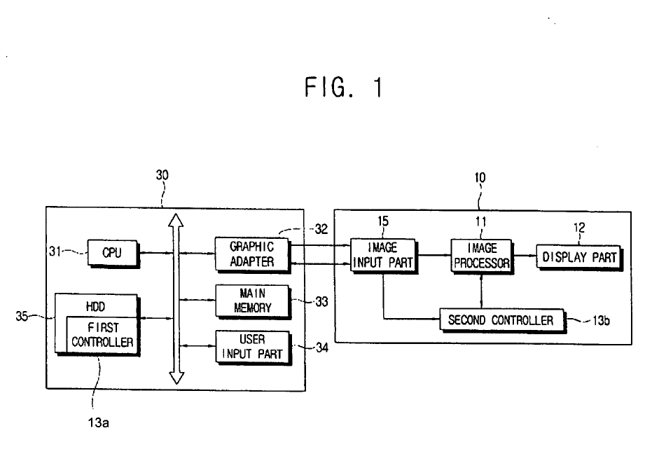

FIG. 1 illustrates a display apparatus 10 and computer combination 30 according to an embodiment of the present general inventive concept. Referring to FIG. 1, the display apparatus 10 and computer 30 combination includes a controller having a first controller 13a and a second controller 13b. The display apparatus 10 comprises a display part 12, an image input part 15, an image processor 11 and the second controller 13b.

The display part 12 receives a signal from the image processor 11 to display an image thereon. The display part 12 may be provided as a flat panel display, such as a liquid crystal display (LCD) panel or a plasma display panel (PDP), or a cathode ray tube (CRT), but the present general inventive concept is not limited thereto.

The image processor 11 converts an image signal input through the image input part 15 into a signal which is displayable by the display part 12, and outputs the signal to the display part 12. The image processor 11 may comprise a scaler to scale the image signal and a signal converter to convert the input image signal into a format which is displayable by the scaler, e.g., digital RGB signals. The signal converter may comprise a transition minimized differential signaling (TMDS) receiver, an A/D converter, a video decoder, a tuner, etc., corresponding to a video format of the image signal input through the image input part 15.

The image input part 15 may comprise a digital connection terminal, such as a digital visual interface (DVI) connector, a D-Sub connector, an antenna, an S-video terminal, a component terminal, etc., corresponding to the video format of the image signal input through the image input part 15.

As illustrated in the embodiment of FIG. 1, an external device, e.g. the computer 30, can be connected to the DVI connector or the D-Sub connector of the image input part 15 of the display apparatus 10 to input the image signal to the display apparatus 10.

The computer 30 comprises a CPU 31, a graphic adapter 32, a main memory 33, a hard disk drive (HDD) 35, and a user input part 34. The first controller 13a can be stored on the HDD 35. The first controller 13a can be a control program loaded to the main memory 33 from the HDD 35, and a user can operate the first controller 13a to perform a predetermined function.

The user input part 34 may be provided in various forms, such as a keyboard, a mouse, etc., to apply a key signal to the computer 30 corresponding to the user's control.

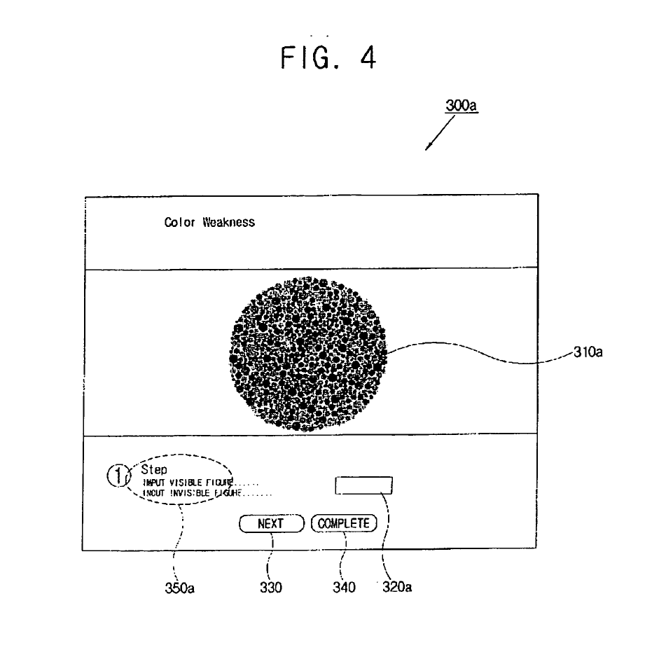

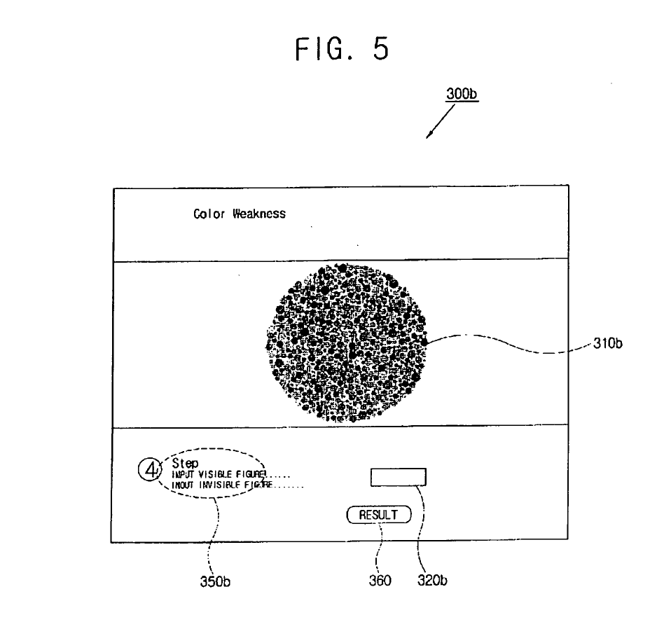

The first controller 13a controls the display apparatus 10 to display one or more first graphic user interfaces 300a and 300b (see FIGS. 4 and 5), and a second graphic user interface on the display part 12. The first controller 13a determines whether the user has color weakness based on one or more first test signals input through the one or more first graphic user interfaces 300a and 300b (see FIGS. 4 and 5), and a degree of the color weakness based on a second test signal input through the second graphic user interface. The second controller 13b sets a color weakness mode of the display apparatus 10 corresponding to the degree of the color weakness determined by the first controller 13a.

As described above, the controller of the display apparatus 10 and computer 30 combination illustrated in the embodiment of FIG. 1 comprises the first controller 13a which is provided in the computer 30, and the second controller 13b which is provided in the display apparatus 10.

The first controller 13a operates by the computer 30 and transmits image signals corresponding to the first graphic user interfaces 300a and 300b (see FIGS. 4 and 5) and the second graphics user interface, to the display apparatus 10. The first controller 13a determines whether the user has the color weakness and the degree of the color weakness according to the first and second test signals.

The second controller 13b controls the image processor 11 to change the color display characteristics of the image displayed on the display part 12 according to the degree of the color weakness determined by the first controller.

The first controller 13a and the second controller 13b can communicate with each other through the graphic adaptor 32 using a DDC communication line, but the present general inventive concept is not limited thereto. For example, the first controller 13a and the second controller 13b can alternatively communicate with each other wirelessly.

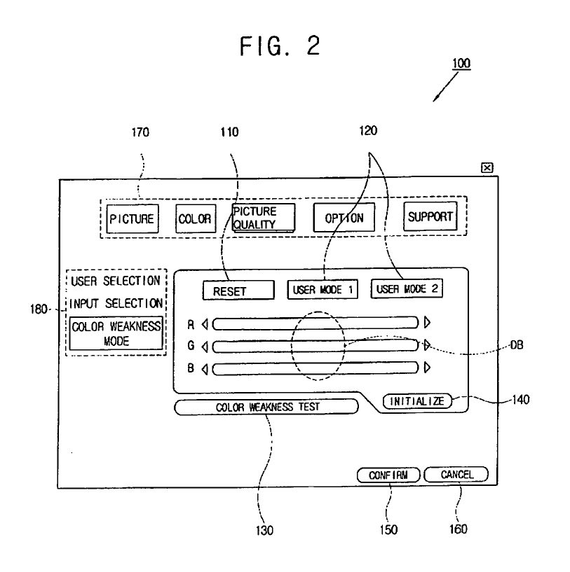

FIGS. 2-9 illustrate graphic user interfaces displayable on the display part 12 under the control of the first controller 13a. Referring to FIGS. 2 through 9, a process of controlling the display apparatus 10 according to an embodiment of the present general inventive concept will be described in detail.

When the first controller 13a operates in the computer 30, the first controller 13a controls the display apparatus 10 to display a color weakness set graphic user interface 100 on the display part 12, as illustrated in FIG. 2.

The color weakness set graphic user interface 100 comprises a reset menu 110, a color weakness test menu 130, and at least one color weakness mode menu 120 to select at least one color weakness mode. For example, as illustrated in FIG. 2, the color weakness set graphic user interface 100 is provided with two color weakness mode menus 120, but the number thereof is not limited thereto, such as for example, three or more.

If the user selects the reset menu 110 using the user input part 34, the first controller 13a applies a reset control signal corresponding to selection of the reset menu 110 to the second controller 13b through the DDC communication line. In response to the reset control signal, the second controller 13b controls the image processor 11 to set the color display characteristics of the image displayed on the display part 12 to a predetermined normal mode.

If the user selects the color weakness mode menu 120 using the user input part 34, the first controller 13a applies a control signal corresponding to a preset color weakness mode corresponding to the selected color weakness mode menu 120 to the second controller 13b through the DDC communication line. In response to the control signal, the second controller 13b controls the image processor 11 to set the color display characteristics of the image displayed on the display part 12 to the corresponding color weakness mode.

The color weakness set graphic user interface 100 may further comprise a main function menu 170 and a sub function menu 180. The main function menu 170 includes selectable menus that group together similar functions to adjust the display conditions of the the display part 12. For example, as illustrated in FIG. 2, the main function menu 170 can include a picture menu, a color menu, a picture quality menu, an option menu, and a support menu. The sub function menu 180 is provided to select a sub function with respect to each of the menus provided in the main function menu 170.

The color weakness set graphic user interface 100 can be displayed on the display part 12, as illustrated in FIG. 2, if the color weakness mode is selected from the sub function menu 180 of the option menu of the main function menu 170.

The color weakness set graphic user interface 100 may further comprise an initialization menu 140. If the user selects the initialization menu 140 using the user input part 34, the first controller 13a initializes the color weakness mode which is set corresponding to the respective color weakness mode menu 120. Here, the initialization of the color weakness mode may refer to conversion to a factory mode or conversion of a level of the respective colors to a preset value.

The color weakness set graphic user interface 100 may further comprise a drag bar menu DB including a red control drag bar, a green control drag bar, and a blue control drag bar. If the user selects one of the color weakness mode menus 120, the first controller 13a activates the red control drag bar, the green control drag bar, and the blue control drag bar corresponding to the selection of the color weakness mode menu 120 to be adjustable through the user input part 34.

The user can then control at least one of the red control drag bar, the green control drag bar, and the blue control drag bar using the user input part 34 to adjust a level of the corresponding color according to the control of the corresponding drag bar. When the user controls one of the red, green, and blue control drag bars, the first controller 13a applies a control signal according to the control of the drag bar to the second controller 13b through the DDC communication line, and the second controller 13b adjusts the level of the corresponding color adjusted according to the control signal. That is, the second controller 13b controls the image processor 11 to adjust the level of the corresponding color according to the control signal of the first controller 13a.

The first controller 13a stored the levels of the colors adjusted using the control of the drag bar as the color weakness mode of the selected color weakness mode menu 120. If the user selects the corresponding color weakness mode menu 120 in the future, the first controller 13a then outputs a control signal corresponding to the color weakness mode of the selected color weakness mode menu 120 to the second controller 13b. The second controller 13b controls the image processor 11 to display the image on the display part 12 using the levels of the colors stored as the selected color weakness mode.

The color weakness mode menu 120 can also include a confirm menu 150 and a cancel menu 160. The confirm menu 150 can be selected to complete a level adjusting process after storing the conditions set through the red, green, and blue control drag bars of the color weakness set graphic user interface 100. The cancel menu 160 can be selected to complete the level adjusting process without storing the conditions set through the red, green, and blue control drag bars of the color weakness set graphic user interface 100.

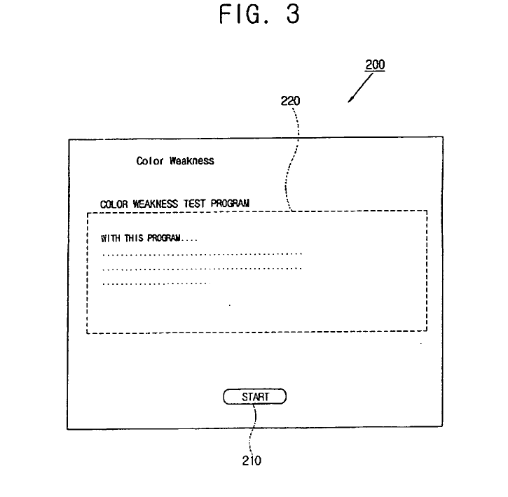

If the color weakness test menu 130 is selected, the first controller 13a controls the display apparatus 10 to display a determination process graphic user interface 200, as illustrated in FIG. 3, or the first graphic user interfaces 300a and 300b, as illustrated in FIGS. 4 and 5, on the display part 12.

Referring to FIG. 3, the first controller 13a may control the display apparatus 10 to display the determination process graphic user interface 200, which displays color weakness determination process information 220 on the display part 12. The determination process graphic user interface 200 displays the determination process information 220 to inform the user of information regarding the color weakness determination process, and is provided with a start menu 210 to start the color weakness determination process.

When the start menu 210 of the determination process graphic user interface 200 is selected, the first controller 13a controls the display apparatus 10 to sequentially display the one or more first graphic user interfaces 300a and 300b, as illustrated in FIGS. 4 and 5. It is also possible that the first controller 13a controls the display apparatus 10 to sequentially display the one or more first graphic user interfaces 300a and 300b in response to the selection of the color weakness test menu 130 of the color weakness set graphic user interface 100, instead of displaying the determination process graphic user interface 200 before the first user interfaces 300a and 300b.

Referring to FIGS. 4 and 5, the one or more first user interfaces 300a and 300b are sequentially displayed at the display part 12. The respective first graphic user interfaces 300a and 300b may comprise color weakness test images 310a and 310b, and test input windows 320a and 320b. The first graphic user interfaces 300a and 300b display the color weakness test images 310a and 310b to determine whether the user has the color weakness. The user can then input figures or characters in the test input windows 320a and 320b corresponding to figures and characters displayed on the color weakness test images 310a and 310b. The figures or characters input to the test windows 320a and 320b are received by the first controller 13a as first test signals, and used by the first controller 13a to determine whether the user has the color weakness.

The first controller 13a determines whether the user has the color weakness based on whether the respective sequentially displayed test images 310a and 310b are identical with the corresponding first test signals. For example, if the color weakness test images 310a and 310b are not identical with the first test signal a predetermined number of times in a test conducted through the sequentially displayed first graphic user interfaces 300a and 300b, the first controller 13a determines that the user has the color weakness. If the color weakness test images 310a and 310b are identical with the first test signals the predetermined number of times in the test conducted through the sequentially displayed first graphic user interfaces 300a and 300b, the first controller 13a determines that the user has normal color vision.

As illustrated in FIGS. 4 and 5, there are provided two tests (i.e., two first graphic user interfaces 300a and 300b each including the respective color weakness test image 310a and 310b) for determining if the color weakness test images 310a and 310b are identical with the first test signals. However, the present general inventive concept is not limited thereto, and there may alternatively be provided three or more tests depending on accuracy of the test. Furthermore, the first controller 13a may determine that the user has the color weakness when the color weakness test images 310a and 310b are not identical with the first test signals, one, two, or more times.

As illustrated in FIG. 4, the first graphic user interface 300a may include a next menu 330. When the next menu 330 is selected, the first controller 13a controls the display apparatus 10 to display the next sequentially displayed first graphic user interface 300b to move to the next test in the color weakness determination process.

As illustrated in FIG. 4, the first graphic user interface 300a can include a complete menu 340 to select completion of the color weakness determination process. If the complete menu 340 is selected, the first controller 13a completes the process of determining whether the user has the color weakness. The first graphic user interfaces 300a and 300b can also include information display blocks 350a and 350b to provide information to describe the currently displayed test of the color weakness determination process.

As illustrated in FIG. 5, a final one of the sequentially displayed first graphic user interfaces 300b can include a result menu 360 to display results of the color weakness determination process conducted through the first graphic user interfaces 300a and 300b. When the result menu 360 is selected, the first controller 13a provides the results of the color weakness determination to the user by controlling the display apparatus 10 to display the results on the display part 12.

For example, if the color weakness test images 310a and 310b are identical with the first test signals more than the predetermined number of times, the first controller 13a controls the display apparatus 10 to display information notifying the user that the user has the normal color vision, e.g., a normal vision information display window (not shown) comprising a sentence such as “you have no color weakness”, on the display part 12. It is possible that the normal vision information display window comprises a confirm menu. When the user selects the confirm menu, the first controller 13a can complete the process of determining the color weakness.

If the color weakness test images 310a and 310b are not identical with the first test signals more than the predetermined number of times, i.e., if the user is determined to have the color weakness, the first controller 13a controls the display apparatus 10 to display a second graphic user interface on the display part 12 to determine a degree of the color weakness.

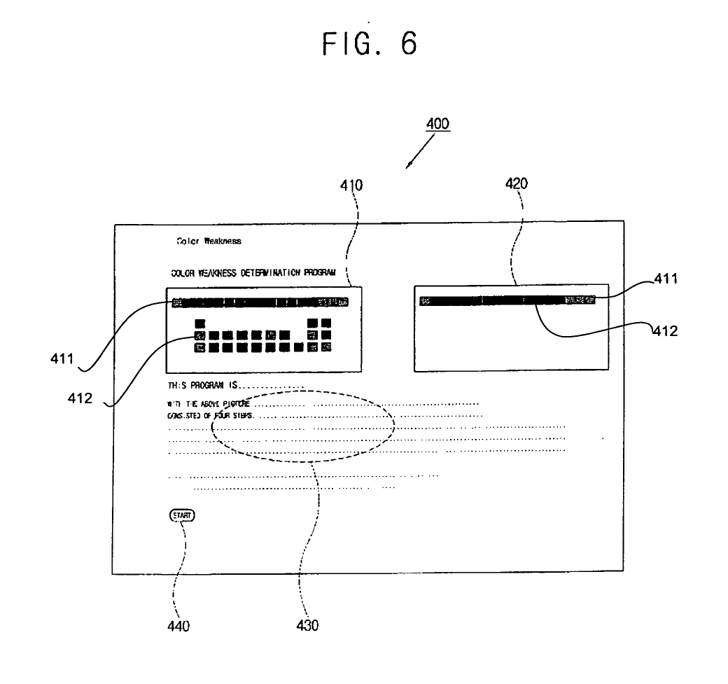

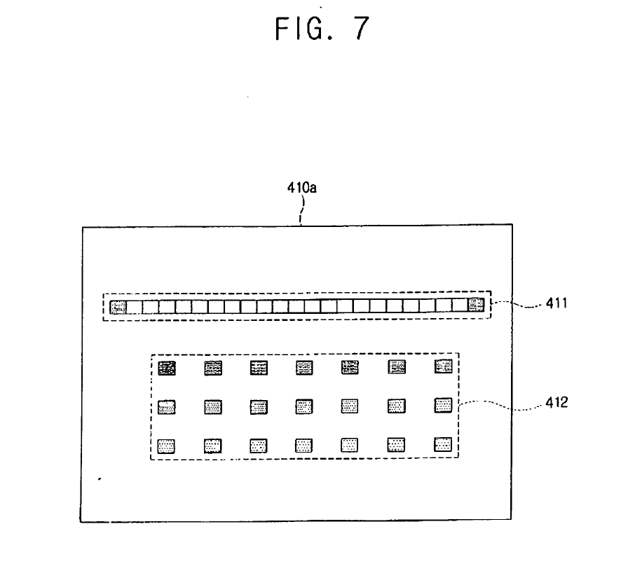

The second graphic user interface may comprise an information graphic user interface 400 (see FIG. 6) to display information regarding a process of determining the degree of the color weakness, and a determination graphic user interface 410a (see FIG. 7) to determine the degree of the color weakness.

FIG. 6 illustrates an example of the information graphic user interface 400. Referring to FIG. 6, the information graphic user interface 400 may comprise a first gradation block 410 and a second gradation block 420.

The first gradation block 410 displays a gradation range block 411 to be initially displayed on the determination graphic user interface 410a, and a plurality of color gradation boxes 412 to be arranged by the user in the gradation range block 411. The second gradation block 420 displays the color gradation boxes 412 of the first gradation block 410 arranged correctly in the gradation range block 411. That is, the second gradation block 420 displays the arrangement of the color gradation boxes 412 in the gradation range block 411 corresponding to the user having the normal color vision.

The information graphic user interface 400 is also provided with an information block 430 to display information regarding the process of determining the degree of the color weakness, e.g., information about arranging the gradation boxes 412 in the first gradation block 410 in the arrangement displayed in the second gradation block 420.

When the user selects a start menu 440 which is provided in the information graphic user interface 400, the first controller 13a controls the display apparatus 10 to sequentially display the determination graphic user interface 410a with respect to the plural colors (i.e., red, green, and blue). The user then arranges each respective determination graphic user interface 410a in the arrangement of the second gradation block 420 of the information graphic user interface 400. The first controller 13a receives the color arrangement of each respective determination graphic user interface 410a as a second test signal and determines the degree of the color weakness with respect to the corresponding color.

FIG. 7 illustrates an example of the determination graphic user interface 410a. Referring to FIG. 7, the determination graphic user interface 410a has a shape corresponding to the first gradation block 410 of the information graphic user interface 400. The determination graphic user interface 410a is provided with the gradation range block 411 and the plurality of color gradation boxes 412 to be arranged in the gradation range block 411. The user arranges the color gradation boxes 412 in the gradation range block 411 according to a degree of color saturation. The first controller 13a determines the degree of color weakness with respect to the corresponding color according to the arrangement by the user. That is, the first controller 13a receives the second control signal corresponding to the arrangement of the color gradation boxes 412 of each color and compares the second control signal with the correct arrangement of the color gradation boxes 412 as displayed in the second gradation box 420 of the information graphic user interface 400. The first controller 13a determines the degree of the color weakness with respect to each color based on the comparison.

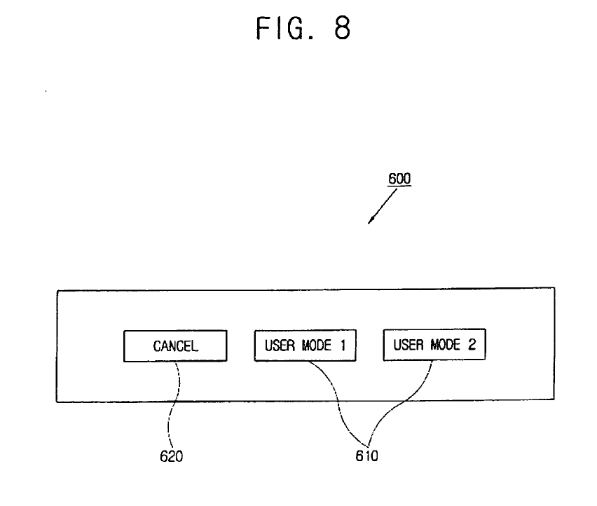

When the process of determining the degree of the color weakness conducted through the determination graphic user interface 410a is completed, the first controller 13a controls the display apparatus 10 to display a mode set window 600 (see FIG. 8) which is provided with one or more determination mode menus 610 corresponding to the respective color weakness mode menus 120 of the color weakness set graphic user interface 100, on the display part 12.

If the user selects one of the determination mode menus 610, the first controller 13a sets a color weakness mode corresponding to the determined degree of the color weakness as the color weakness mode of the color weakness mode menu 120 corresponding to the selected determination mode menu 610. That is, the first controller 13a determines color display characteristics of the display part 12 corresponding to the determined degree of the color weakness and stores the determined color display characteristics as the color weakness mode of the color weakness mode menu 120 corresponding to the selected determination mode menu 610. Accordingly, when the user selects the corresponding color weakness mode menu 120 of the color weakness set graphic user interface 100, the first controller 13a applies the control signal corresponding to the color weakness mode corresponding to the determined degree of the color weakness to the second controller 13b. In response to the control signal, the second controller 13b controls the image processor 11 to display the image displayed on the display part 12 using the corresponding color weakness mode. That is, the second controller 13b controls the image processor 11 to adjust the color display characteristics of the display part 12 to the color display characteristics stored as the color weakness mode of the corresponding color weakness mode menu 120.

If the user selects a cancel menu 620 which is provided in the mode set window 600, the process of determining the degree of the color weakness is completed without setting or storing the color weakness mode corresponding to the determined degree of the color weakness.

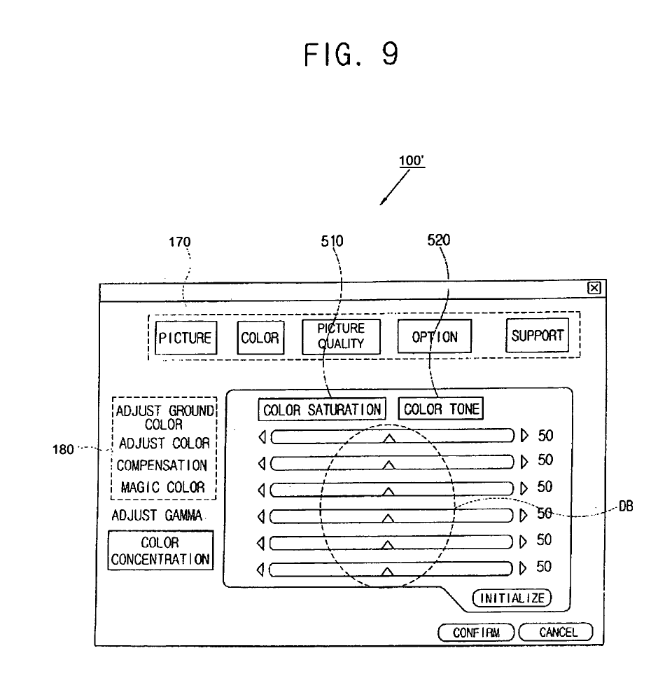

FIG. 9 illustrates the color weakness set graphic user interface 100′ as displayed on the display part 12 if the user selects the color menu of the main function menu 170 and a color concentration menu of the sub function menu 180.

Referring to FIG. 9, the color weakness set graphic user interface 100′ includes a color saturation menu 510 and a color tone menu 520. The user may use a drag bar DB of the color saturation menu 510 and the color tone menu 520 to adjust color saturation and color tone of the image displayed on the display part 12. If the second controller 13b controls the image processor 11 to display the image on the display part 12 in the color weakness mode corresponding to a selected one of the color weakness mode menus 120, the first controller 13a may control the drag bar DB of the color saturation menu 510 and the color tone menu 520 to be displayed in a non-controllable state. Accordingly, if the user tries to adjust the drag bar DB of the color saturation menu 510 or the color tone menu 520, the first controller 13a can display an information window (not shown) which overlaps with the color weakness set graphic user interface 100′ and provides information informing the user that the color weakness mode is already set.

As illustrated in FIG. 1, the computer 30 is connected with a single display apparatus 10. However, if the computer 30 is connected with two or more display apparatuses 10 and the display apparatuses 10 support the functions described above, the first controller 13a may set the color weakness mode individually with respect to each display apparatus 10. If the color weakness mode is set in a single display apparatus 10, the first controller 13a may also apply the set color weakness mode to all of the display apparatuses 10. For example, if a user sets the color weakness mode corresponding to one of the color weakness mode menus 120 of the color weakness set graphic user interface 100 and selects the corresponding color weakness mode menu 120, the color weakness mode may be applicable to all of the display apparatuses 10. The first controller 13a then applies the control signal corresponding to the selected color weakness mode to the respective display apparatuses 10. The second controller 13b provided in each display apparatus 10 controls the respective image processor 11 to display the image displayed on the display part 12 of the respective display apparatus 10 in the corresponding color weakness mode.

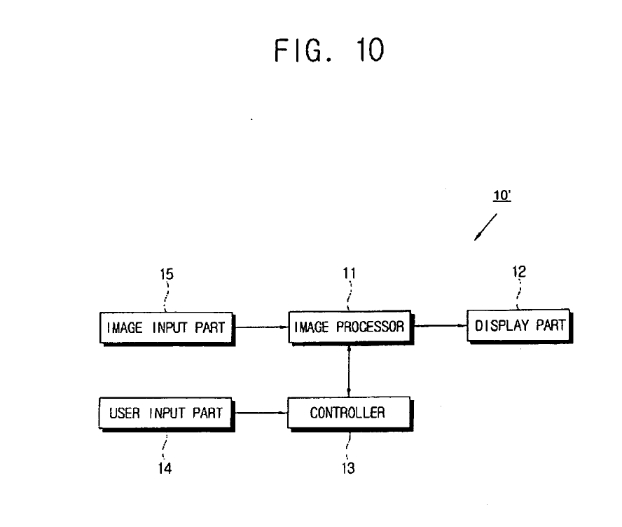

FIG. 10 is a control block diagram illustrating a display apparatus 10′ according to another embodiment of the present general inventive concept. Referring to FIG. 10, the display apparatus 10′ comprises an image input part 15, an image processor 11, a display part 12, a user input part 14, and a controller 13.

The display apparatus 10′ of the embodiment of FIG. 10 differs from the display apparatus 10 of the embodiment of FIG. 1 in that the controller 13 provided in the display apparatus 10′ of FIG. 10 can perform all functions of the first and second controllers 13a and 13b of the computer 30 and the display apparatus 10 of FIG. 1. Accordingly, the controller 13 provided in the display apparatus 10′ controls the display apparatus to display the first graphic user interfaces 300a and 300b and the second graphic user interface on the display part 12, and determines whether a user has the color weakness and the degree of the color weakness. The controller 13 also controls the image processor 11 to adjust the display conditions of the image displayed on the display part 12 according to the determined degree of the color weakness.

The graphics user interfaces described above, such as the first graphic user interfaces 300a and 300b and the second graphic user interface, may be displayed on the display part 12 by an on screen display (OSD) generator (not shown), which is provided in the image processor 11.

The user input part 14 of the display apparatus 10′ of the embodiment of FIG. 10 may be provided as a control button which is disposed on a surface of the display apparatus 10′ or a remote controller.

It is possible for the present general inventive concept to be realized on a computer-readable recording medium as a computer-readable code. Computer-readable recording mediums include many types of recording devices that store computer system-readable data. ROMs, RAMs, CD-ROMs, magnetic tapes, floppy discs, optical data storage, etc. are used as computer-readable recording mediums. Computer-readable recording mediums can also be realized in the form of carrier waves (e.g., transmission via Internet).

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of controlling a display apparatus having a display part to display an image thereon, the method comprising:
displaying a first graphic user interface on the display part to determine whether a user has color weakness;
determining whether the user has the color weakness based on a first test signal which is input through the first graphic user interface;
displaying a second graphic user interface having an information graphic user interface to display information regarding a process of determining a degree of the color weakness, and at least one determination graphic user interface to determine the degree of the color weakness based on at least one gradation of brightness and saturation with respect to at least one color, on the display part if it is determined that the user has the color weakness;
determining the degree of the color weakness based on a second test signal which is input through the second graphic user interface; and
setting a color weakness mode corresponding to the determined degree of the color weakness.

2. The method according to claim 1, further comprising:
displaying a color weakness set graphic user interface which is provided with a reset menu, a color weakness mode menu to select at least one color weakness mode and a color weakness test menu, on the display part, wherein
the displaying of the first graphic user interface on the display part is performed by selecting the color weakness test menu of the displayed color weakness set graphic user interface.

3. The method according to claim 2, further comprising:
displaying an image on the display part in a normal mode corresponding to selection of the reset menu of the displayed color weakness set graphic user interface; and
when the at least one color weakness mode of the color weakness mode menu is selected, displaying the image on the display part in a color weakness mode which is set corresponding to the selected color weakness mode.

4. The method according to claim 2, wherein the color weakness set graphic user interface further comprises a red control drag bar, a green control drag bar, and a blue control drag bar, the method further comprising:
selecting one of the at least one color weakness mode of the color weakness mode menu;
activating the red control drag bar, the green control drag bar, and the blue control drag bar in a controllable state corresponding to the selection of the color weakness mode; and
displaying the image on the display part corresponding to the control of at least one of the red control drag bar, the green control drag bar, and the blue control drag bar, as the selected color weakness mode.

5. The method according to claim 4, wherein the color weakness set graphic user interface further comprises an initialization menu, the method further comprising:
initializing the color weakness mode corresponding to the selection of the initialization menu.

6. The method according to claim 2, wherein the first graphic user interface comprises a color weakness test image and a test input window to input the first test signal corresponding to the color weakness test image.

7. The method according to claim 6, wherein the determining of whether the user has the color weakness comprises:
displaying at least two color weakness test images on the first graphic user interface sequentially;
inputting the first test signal in the test input window corresponding to each of the sequentially displayed color weakness test images; and
determining that the user has the color weakness if the color weakness test images and the first test signal are not identical to each other more than a predetermined number of times.

8. The method according to claim 7, wherein the first graphic user interface further comprises a next menu, wherein
the displaying of the at least two color weakness test images sequentially comprises displaying a next one of the at least two color weakness test images on the first graphic user interface whenever the next menu is selected.

9. The method according to claim 7, further comprising:
displaying a normal vision information display window on the display part to display information representing that the user has a normal color vision if the color weakness test images and the first test signal are identical to each other more than the predetermined number of times.

10. The method according to claim 7, wherein the displaying of the second graphic user interface on the display part is performed when it is determined that the user has the color weakness.

11. The method according to claim 10, wherein the setting of the color weakness mode corresponding to the determined degree of the color weakness comprises:
displaying a mode set window which includes at least one determination mode menu corresponding to the at least one color weakness mode of the color weakness mode menu of the color weakness set graphic user interface, on the display part when the degree of the color weakness is determined through the determination graphic user interface; and
setting the color weakness mode corresponding to the determined degree of the color weakness as the at least one color weakness mode of the color weakness mode menu corresponding to the at least one determination mode menu if the at least one determination mode menu is selected.

12. A method of controlling a display apparatus, comprising:
receiving first input signals and determining whether a user has a color weakness based on the first input signals;
receiving second input signals and determining a degree of the color weakness based on the second input signals if it is determined that the user has the color weakness; and
automatically adjusting display characteristics of the display apparatus according to the determined degree of the color weakness.

13. The method according to claim 12, wherein the receiving of the first input signals and determining whether the user has a color weakness based on the first input signals comprises:
sequentially displaying a plurality of test images;
receiving the first input signals, each corresponding to one of the test images; and
comparing the received first input signals with the displayed test images to determine whether the user has the color weakness.

14. The method according to claim 13, wherein the comparing of the received first input signals with the displayed test images comprises:
determining that the user has the color weakness when a predetermined number of the received first input signals are not identical to the corresponding test images.

15. The method according to claim 12, wherein the receiving of the second input signals and determining of the degree of the color weakness based on the second input signals comprises:
displaying a plurality of gradations of each of a plurality of colors to be arranged by the user in order of color saturation;
receiving the second test signals, each corresponding to the arrangement of the gradations of one of the colors by the user; and
comparing the second test signals with a predetermined normal arrangement of the gradations of each color to determine the degree of the color weakness for each color.

16. The method according to claim 12, wherein the adjusting of the display characteristics of the display apparatus according to the determined degree of the color weakness comprises:
determining level values of each of a plurality of colors of the display apparatus to compensate for the determined degree of the color weakness; and
storing the determined level values as a color weakness mode selectable to set levels of each of the plurality of colors to the determined level values.

17. The method according to claim 12, further comprising:
setting the display characteristics of the display apparatus to a predetermined normal mode when it is determined that the user does not have the color weakness.

18. A display apparatus comprising:
a display part to display an image thereon;
an image processor to convert an image signal into a signal which is displayable by the display part; and
a controller to control the display part to display a first graphic user interface to determine whether a user has color weakness and a second graphic user interface having an information graphic user interface to display information regarding a process of determining a degree of the color weakness and at least one determination graphic user interface to determine the degree of the color weakness based on at least one gradation of brightness and saturation with respect to at least one color, to determine whether the user has the color weakness based on a first test signal which is input through the first graphic user interface, to determine the degree of the color weakness based on a second test signal which is input through the second graphic user interface, and to set a color weakness mode corresponding to the determined degree of color weakness.

19. The display apparatus according to claim 18, wherein the controller comprises:
a first controller which is provided in an external device to apply the image signal to the image processor, to apply graphic user interface image signals corresponding to the first graphic user interface and the second graphic user interface to the image processor, and to determine whether the user has the color weakness and the degree of the color weakness according to the first test signal and the second test signal; and
a second controller to control the image processor to change color display characteristics of the image displayed on the display part according to a control signal from the first controller corresponding to the determined degree of the color weakness.

20. The display apparatus according to claim 19, wherein the first and second controllers communicate with each other through a DDC communication line.

21. The display apparatus according to claim 18, wherein the controller controls the display part to display a color weakness set graphic user interface which includes a reset menu, a color weakness test menu, and a color weakness mode menu to select at least one color weakness mode, and to display the first graphic user interface when the color weakness test menu is selected.

22. The display apparatus according to claim 21, wherein the controller controls the image processor to set color display characteristics of the image displayed on the display part to a predetermined normal mode when the reset menu is selected, and controls the image processor to set the color display characteristics of the image displayed on the display part to correspond to the selected at least one color weakness mode when the at least one color weakness mode of the color weakness mode menu is selected.

23. The display apparatus according to claim 21, wherein the color weakness set graphic user interface further comprises a red control drag bar, a green control drag bar and a blue control drag bar, and
the controller activates the red control drag bar, the green control drag bar, and the blue control drag bar to be in a controllable state when one of the at least one color weakness mode of the color weakness menu is selected, and controls the image processor to adjust color display characteristics of the image displayed on the display part corresponding to the control of at least one of the red control drag bar, the green control drag bar and the blue control drag bar.

24. The display apparatus according to claim 21, wherein the color weakness set graphic user interface further comprises an initialization menu, and the controller initializes a preset color weakness mode according to selection of the initialization menu if the initialization menu is selected.

25. The display apparatus according to claim 24, wherein the first graphic user interface includes at least two color weakness test images sequentially displayed on the display part, and the controller determines that the user has the color weakness if the first test signal input corresponding to the sequentially displayed color weakness test images is not identical with the color weakness test images a predetermined number of times.

26. The display apparatus according to claim 25, wherein the controller controls the display part to display an information display window to display information that a user has a normal color vision if the first test signal is identical with the color weakness test images more than the predetermined number of times.

27. The display apparatus according to claim 25, wherein the controller controls the display part to display a mode set window which is provided with at least one determination mode menu corresponding to the at least one color weakness mode of the color weakness mode menu of the color weakness set graphic user interface when the degree of the color weakness is determined through the determination graphic user interface, and sets the color weakness mode corresponding to the determined degree of the color weakness as the at least one color weakness mode of the color weakness mode menu corresponding to the at least one determination mode menu if the at least one determination mode menu is selected.

28. A display apparatus, comprising:
a display part to display first and second graphic user interfaces; and
a controller to determine whether a user has a color weakness based on the displayed first graphic user interface, to determine a degree of the color weakness based on the displayed second graphic user interface when it is determined that the user has the color weakness, and to adjust display characteristics of the display part according to the determined degree of the color weakness.

29. The display apparatus according to claim 28, wherein the first graphic user interface comprises:
a plurality of test images sequentially displayed by the display part; and
a test input window corresponding to each of the plurality of test images to input test signals corresponding to each of the plurality test images.

30. The display apparatus according to claim 29, wherein the controller compares the input test signals corresponding to the sequentially displayed test images and determines that the user has the color weakness when a predetermined number of the test signals are not identical to the corresponding test images.

31. The display apparatus according to claim 28, wherein the second graphic user interface comprises:
a plurality of gradation boxes of each of a plurality of colors; and
a gradation range block corresponding to each color to arrange the plurality of gradation boxes of the respective color therein.

32. The display apparatus according to claim 31, wherein the controller compares the arrangement of the gradation boxes of each color in the respective gradation range block with predetermined gradation box arrangements of each color to determine the degree of the color weakness with respect to each color.

33. The display apparatus according to claim 28, further comprising:
a user input part to input information into the first and second graphic user interfaces displayed on the display part.

34. A display apparatus, comprising:
a display part to display a plurality of test images thereon to test whether a user has a color weakness and to display a plurality of gradations of each of a plurality of colors thereon to test a degree of the color weakness;
a user input part to generate first signals corresponding to the plurality of test images displayed on the display, to arrange the plurality of gradations of each of the plurality of colors according color saturation, and to generate second signals corresponding to the arrangement of the gradations of each of the plurality of colors; and
a controller to compare the first signals to the test images to determine whether the user has the color weakness and to compare the second signals with a predetermined normal arrangement of the gradations of each of the plurality of colors to determine the degree of the color weakness for each of the plurality of colors when is determined that the user has the color weakness.

35. A display system, comprising:
a display unit comprising a display part to display an image thereon and a display controller to control display characteristics of the display part; and
a computer communicating with the display unit and comprising a control unit to control the display unit to display a first graphic user interface and a second graphic user interface, to determine whether a user has a color weakness based on the displayed first graphic user interface, to determine a degree of the color weakness based on the displayed second graphic user interface when it is determined that the user has the color weakness, and to control the display controller to adjust the display characteristics of the display part according to the determined degree of the color weakness.

36. A computer readable recording medium having executable codes to perform a method of controlling a display apparatus having a display part to display an image thereon, the method comprising:
displaying a first graphic user interface on the display part to determine whether a user has color weakness;
determining whether the user has the color weakness based on a first test signal which is input through the first graphic user interface;
displaying a second graphic user interface having an information graphic user interface to display information regarding a process of determining a degree of the color weakness, and at least one determination graphic user interface to determine the degree of the color weakness based on at least one gradation of brightness and saturation with respect to at least one color, on the display part if it is determined that the user has the color weakness;
determining the degree of the color weakness based on a second test signal which is input through the second graphic user interface; and
setting a color weakness mode corresponding to the determined degree of the color weakness.

37. A computer readable recording medium having executable codes to perform a method of controlling a display apparatus, the method comprising:
receiving first input signals and determining whether a user has a color weakness based on the first input signals;
receiving second input signals and determining a degree of the color weakness based on the second input signals if it is determined that the user has the color weakness; and
adjusting display characteristics of the display apparatus according to the determined degree of the color weakness.
